(19) United States
(12) Patent Application Publication
(10) Pub. No.: US 2007/0121227 A1
(43) Pub. Date: May 31, 2007

(54) Brightness enhancement film having curved prism units and light scattering particles

(75) Inventors: Jing-Wei Wang, Tainan (TW); Jian-Zhi Chen, Pingtung County (TW); Ching-Chin Wu, Tainan (TW); Shih-Chieh Tang, Tainan (TW)

Correspondence Address: BACON & THOMAS, PLLC, 625 SLATERS LANE, FOURTH FLOOR, ALEXANDRIA, VA, 22314, US

(73) Assignee: EFUN TECHNOLOGY CO., LTD., Tainan (TW)

(21) Appl. No.: 11/653,995

(22) Filed: Jan. 17, 2007

Related U.S. Application Data
(63) Continuation-in-part of application No. 10/882,346, filed on Jul. 2, 2004.

(30) Foreign Application Priority Data
Oct. 19, 2006 (TW) 95138641

(51) Int. Cl. G02B 5/04

(52) U.S. Cl. 359/831

(57) ABSTRACT

A brightness enhancement film includes a substrate, a plurality of curved prism units and a plurality of light scattering particles. The curved prism units are extended in parallel and formed on a first surface of the substrate. Each of the curved prism units includes at least one meandering surface to provide with changes in curvature. Thus, the meandering surface of the curved prism unit is able to refract incident light in two dimensions with respect to the substrate that may enhance entire light-collecting efficiency in two dimensions. The light scattering particles are disposed in the curved prism units.

### CROSS REFERENCE TO RELATED APPLICATION

This application is a continuation-in-part application of U.S. patent application Ser. No. 10/882,346, filed on Jul. 2, 2004.

### BACKGROUND OF THE INVENTION

1. Field of the Invention

The present invention relates to a brightness enhancement film having curved prism units and light scattering particles. Particularly, the present invention relates to a brightness enhancement film having curved prism units and light scattering particles embedded therein. More particularly, the present invention relates to a brightness enhancement film having curved prism units each of which is extended in a meandering line to provide changes in curvature. The brightness enhancement film is applied to a Liquid Crystal Display that improves the entire optical refractive characteristic.

2. Description of the Related Art

Referring to FIGS. 1 and 2, International Patent Publication No. WO 96/23649 discloses a brightness enhancement film 9 including a base layer 91 and a plurality of prisms 92 juxtaposed in order on a first surface of the base layer 91. Each of the prisms 92 consists of a first flat facet and a second flat facet adapted to refract lights to produce a condense light.

However, the first flat facet and the second flat facet of the prisms 92 are flat surfaces to refract lights in one dimension with respect to the first surface (i.e. emitting surface) of the brightness enhancement film 9. The first flat facet and the second flat facet refract a light beam 93 which is transmitted from a second surface (i.e. incident surface) of the base layer 91. The light beam 93 may have an angle of incidence with respect to a longitudinal direction of the second surface of the base layer 91 while the light beam 93 penetrates through the first flat facet and the second flat facet of the prisms 92. On the second surface of the base layer 91, the incident angle of the light beam 94 may be smaller than a value in the range of 6 degrees to 9 degrees. In light emitting, the relatively small angle of incidence of the light beam 94 may generate total internal reflection on the first flat facet and the second flat facet of the prisms 92. Disadvantageously, the light beam 94 cannot penetrate through the prisms 92. Consequently, this results in poor transmission efficiency of emitted lights of the brightness enhancement film 9.

A conventional light diffusing film is also disclosed in International Patent Publication No. WO 2005/006030, which is titled “OPTICAL FILM FOR BACKLIGHT UNIT AND BACKLIGHT UNIT USING THE SAME.” This light diffusing film herein known as an optical film includes a film sheet, a refraction pattern and a plurality of light diffusing particles. The refraction pattern is integrally formed on a surface of the film sheet and the light diffusing particles are distributed in the film sheet and the refraction pattern for enhancing light diffusion.

Another light diffusing film is also disclosed in Japanese Patent Laid-Open Publication No. H09-304607, which is titled “LIGHT DIFFUSING FILM.” This light diffusing film includes a substrate and a light-diffusing layer. The light-diffusing layer is provided on a surface of the substrate for refracting lights which penetrate through the light-diffusing layer. The light-diffusing layer is made from a transparent resin and diffusing particles (i.e. fine particles) scattered therein. The diffusing particles are randomly scattered on a surface of the light-diffusing layer. Accordingly, the light diffusing film provides a finely rugged surface thereon.

Another light diffusing film is also disclosed in U.S. Pat. No. 6,417,831, which is titled “DIFFUSED LIGHT CONTROLLING OPTICAL SHEET, BACK LIGHT DEVICE, AND LIQUID CRYSTAL DISPLAY APPARATUS.” This light diffusing film herein known as an optical sheet is formed with a plurality of prisms on a surface. The prisms contain a fine material having different refractive index with respect to that of the optical sheet. The prism may have a convex part on which to provide fine ruggedness for diffusing lights. Another light diffusing film is also disclosed in U.S. Publication No. 2005/0257363, which is titled “OPTICAL DIFFUSION PLATE APPLIED FOR DIRECT-TYPE BACKLIGHT MODULE AND MANUFACTURING METHOD THEREOF.” This light diffusing film herein known as an optical diffusion plate includes a substrate and a prism array (i.e. saw structure). The light diffusing film is made from materials of an optical resin and an optical diffusion agent. The prism array is formed on a surface of the substrate for refracting lights. The optical diffusion agent contained in the material of the light diffusing film can diffuse lights for enhancing the diffusing effect of the light diffusing film.

Another brightness enhancement film is also disclosed in Taiwanese Pat. Pub. No. M277950, which is titled “PRISM SHEET AND BACKLIGHT MODULE USING THE SAME.” This brightness enhancement film herein known as a prism sheet includes a substrate and a plurality of prisms. The prisms are formed on a surface of the substrate for refracting lights. Light diffusion particles are disposed in the substrate for enhancing the brightness effect of the brightness enhancement film.

The present invention intends to provide a brightness enhancement film having curved prism units and light scattering particles. Each of the curved prism units extends in a meandering line so that at least one surface of the curved prism unit provides changes in curvature, i.e., such that a direction of the meandering surface relative to the longitudinal direction varies along a length of each of the prism units. Thereby, the changes of the curved prism unit in curvature refract light in two dimensions to attenuate the moire phenomenon and the structure of the curved prism units are simplified in such a way as to mitigate and overcome the above problem. Furthermore, the curved prism units contain the light scattering particles for enhancing transmittance of light and reducing total internal reflection of light.

### SUMMARY OF THE INVENTION

The primary objective of this invention is to provide a brightness, enhancement film having curved prism units and light scattering particles contained in the curved prism units. Each of the prism units includes at least one surface extending in a meandering line so as to provide changes in curvature to refract light in two dimensions. Thereby, the curved prism units extending in a meandering line enhances the entire light-collecting efficiency in two dimensions, and the light scattering particles also enhance transmittance of light and reduce total internal reflection of light.

The secondary objective of this invention is to provide a brightness enhancement film having curved prism units which contain light scattering particles for widening angles of emitting light. The light scattering particles can enhance a brightness effect of the brightness enhancement film.

Another objective of this invention is to provide a brightness enhancement film having curved prism units and light scattering particles, wherein the light scattering particles can uniformly scatter light to obtain a perfect degree of the brightness of the brightness enhancement film.

Another objective of this invention is to provide a brightness enhancement film having curved prism units and light scattering particles, wherein the light scattering particles can widen a degree of half luminance angle with respect to an ordinary brightness enhancement film.

Another objective of this invention is to provide a brightness enhancement film having curved prism units and light scattering particles, wherein the light scattering particles can increase a degree of haze of the brightness enhancement film. Also, the light scattering particles can reduce structural defects of the brightness enhancement film.

Another objective of this invention is to provide a brightness enhancement film having curved prism units and light scattering particles to carry out a perfect degree of light diffusion such that a light diffusing film will be omitted in a backlight module.

The brightness enhancement film in accordance with an aspect of the present invention comprises a substrate, a plurality of curved prism units and a plurality of light scattering particles. The curved prism units are extended in parallel and formed on a first surface of the substrate. Each of the curved prism units includes at least one meandering surface to provide with changes in curvature. Thus, the meandering surface of the curved prism unit is able to refract incident light in two dimensions with respect to the substrate that may enhance entire refractive efficiency in two dimensions. The light scattering particles are disposed in the curved prism units.

The substrate and the curved prism units of the brightness enhancement film in accordance with the present invention form a single film, and are made of identical transparent material. Alternatively, the substrate and the curved prism units are made of dissimilar transparent material. Thereby, the brightness enhancement film may widen the scope of application and manufacture.

In a separate aspect of the present invention, the curved prism unit includes a plurality of lateral ridges arranged on the meandering surface.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a perspective view of a brightness enhancement film of International Patent Publication No. WO96/23649 in accordance with the prior art;

FIG. 2 is an enlarged, side elevational view of the brightness enhancement film in accordance with the prior art, depicted in FIG. 1;

FIG. 3 is a perspective view of a brightness enhancement film having curved prism units and light scattering particles in accordance with a first embodiment of the present invention;

FIG. 4 is an enlarged, side elevational view of the brightness enhancement film having curved prism units and light scattering particles in accordance with the first embodiment of the present invention, depicted in FIG. 3;

FIG. 4A is an enlarged, side elevational view of the brightness enhancement film having curved prism units and light scattering particles in accordance with a second embodiment of the present invention;

FIG. 5 is an enlarged, side elevational view of the brightness enhancement film having curved prism units and light scattering in accordance with the preferred embodiment of the present invention;

FIG. 6 is a chart of two curves illustrating percentages of light transmittance and reflection in relation to incident angles of light passing through the brightness enhancement film in accordance with the preferred embodiment of the present invention;

FIG. 7 is a chart of two curves illustrating percentages of transmittance of light in relation to incident angles of light passing through the particle-contained brightness enhancement film in accordance with the preferred embodiment of the present invention, comparing with a particle-free brightness enhancement film;

FIG. 8 is a chart illustrating brightness of various types of brightness enhancement films in relation to visual angles along a horizontal direction of viewing, wherein the brightness enhancement film in accordance with the preferred embodiment of the present invention is applied;

FIG. 9 is a chart, similar to FIG. 8, illustrating brightness of various types of brightness enhancement films in relation to visual angles along a vertical direction of viewing, wherein the brightness enhancement film in accordance with the preferred embodiment of the present invention is applied;

FIG. 10 is a chart illustrating brightness of various types of brightness enhancement films in relation to visual angles along a horizontal direction of viewing, wherein the brightness enhancement film in accordance with the preferred embodiment of the present invention is applied;

FIG. 11 is a chart, similar to FIG. 10, illustrating brightness of various types of the brightness enhancement films in relation to visual angles along a vertical direction of viewing, wherein the brightness enhancement film in accordance with the preferred embodiment of the present invention is applied; and

FIG. 12 is a microscopic image, with a magnification of 1,000 times, of the light scattering particles of the brightness enhancement film in accordance with the preferred embodiment of the present invention.

### DETAILED DESCRIPTION OF THE INVENTION

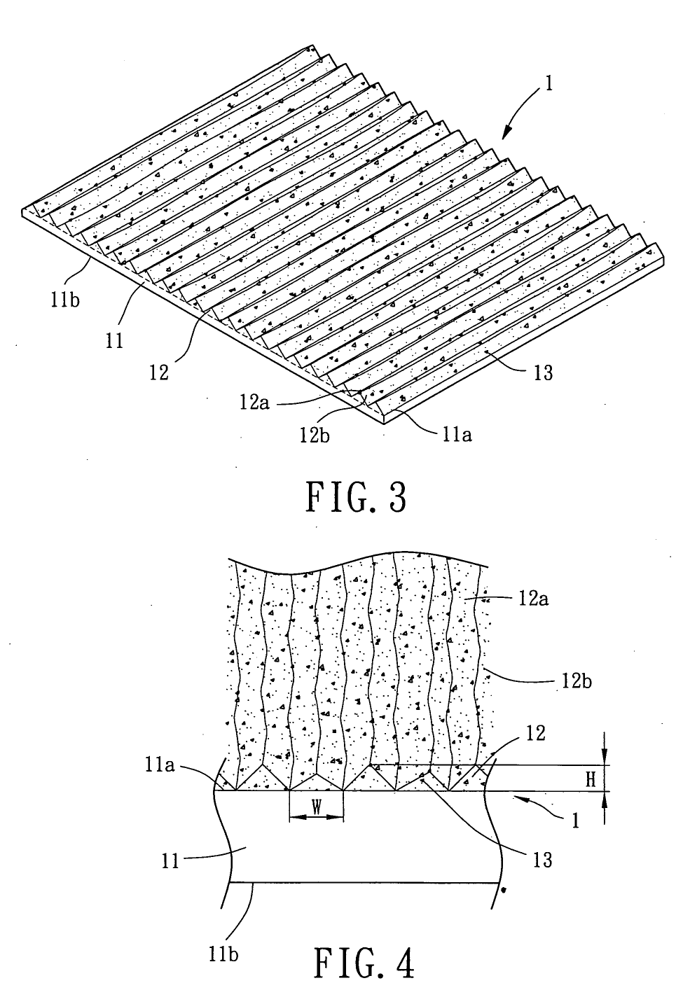

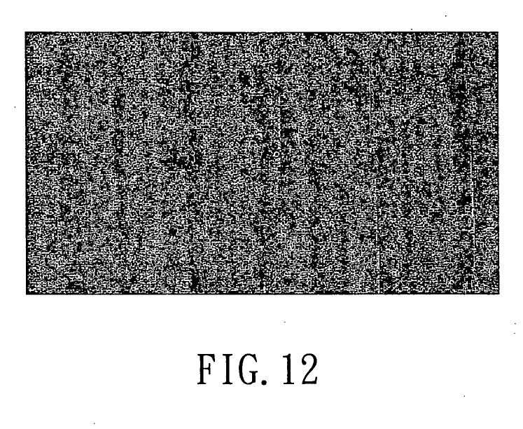

Referring to FIGS. 3 through 5 and 12, a brightness enhancement film 1 in accordance with a first embodiment of the present invention includes a substrate 11 and a plurality of curved prism units 12 which are made of transparent materials to constitute a single film. The brightness enhancement film 1 further includes light scattering particles 13. The substrate 11 includes a first surface 11a and a second surface 11b substantially parallel thereto and thus light is able to penetrate the substrate 1 therebetween. The first surface 11a and the second surface 11b can be regarded as a light-emitting side (i.e. light-exiting side) and a light incident side, and vice versa. The curved prism units 12 constitute a microstructure layer, and are selectively juxtaposed on the first surface 11 a of the substrate 11 which can be one of the light-emitting side and the light incident side. Structurally, each of the curved prism units 12 essentially consists of a first meandering surface 12a and a second meandering surface 12b. The first meandering surface 12a and the second meandering surface 12b of the curved prism unit 12 define a common ridge. Alternatively, the first meandering surface 12a of the curved prism unit 12 and the second meandering surface 12b of the adjacent curved prism unit 12 define a common trough line which is regarded as a common boundary of any two adjacent units of the curved prism units 12.

With continued reference to FIGS. 3 through 5, each route of the curved prism units 12 is longitudinally extended along a meandering line with respect to the substrate 11, and the curved prism units 12 are juxtaposed on the first surface 11a of the substrate 11. With respect to the first surface 11a of the substrate 11, the curved prism units 12 have various vertical heights (H) and various horizontal widths (W). The first meandering surface 12a and the second meandering surface 12b of the curved prism unit 12 are longitudinally extended in a meandering line in order to provide changes in curvature even though the routes of the curved prism units may be essentially parallel. In use, incident light transmitted from the second surface 11b of the substrate 11 is appropriately directed to the curved prism units 12, and thus the curvature of the first meandering surface 12a and the second meandering surface 12b may refract it in two dimensions. Thereby, the curvature of the first meandering surface 12a and the second meandering surface 12b may relatively enhance the entire light-collecting efficiency of the brightness enhancement film in two dimensions.

In a preferred embodiment, an included angle formed between the first meandering surface 12a and the second meandering surface 12b located at the ridge of the curved prism unit 12 is in the range of 70 degrees to 160 degrees, more preferably in the range of 85 degrees to 95 degrees. In another preferred embodiment, the vertical height (H) of the curved prism unit 12 is in the range of 10 μm to 100 μm, more preferably in the range of 20 μm to 75 μm. Alternatively, the vertical heights (H) of the curved prism units 12 are all the same. In another preferred embodiment, the horizontal width (W) of the curved prism unit 12 is in the range of 10 μm to 250 μm, more preferably in the range of 25 μm to 80 μm. In another preferred embodiment, the ridge or the trough line of the curved prism unit 12 meanders in length and the trough line deviates a distance from a center reference line within ±5 μm. Preferably, each of the first meandering surface 12a and the second meandering surface 12b has regular changes or free of regular changes in curvature.

With continued reference to FIGS. 3 through 5, the meandering route of the curved prism unit 12 can relatively attenuate the moire phenomenon, thereby increasing the quality of optical display of the brightness enhancement film.

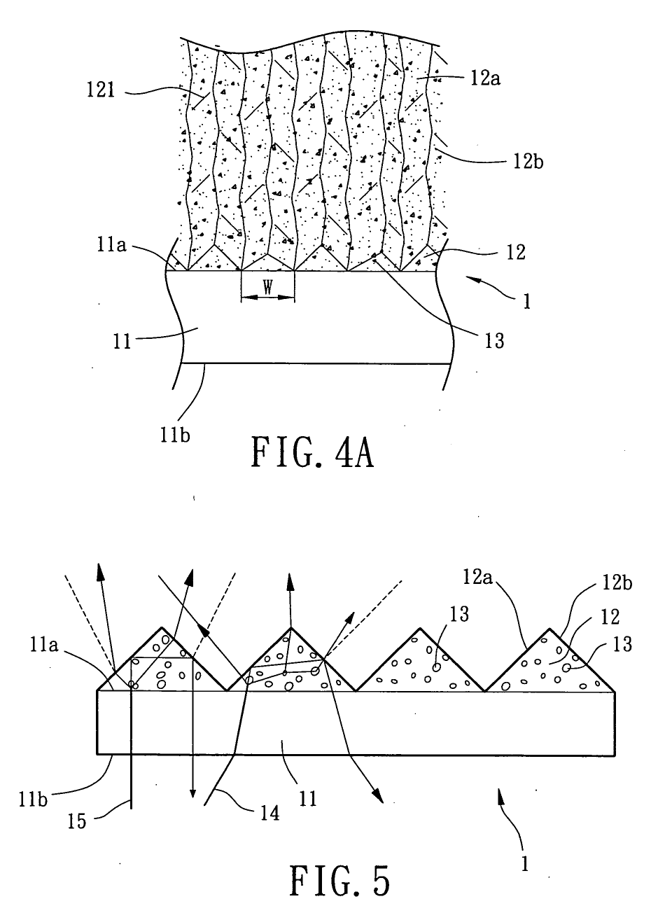

With continued reference to FIGS. 3 and 4, the substrate 11 and the curved prism units 12 are made of similar flexible, transparent material and are integrally formed. In an alternative embodiment, the substrate 11 and the curved prism units 12 are made of dissimilar materials. In manufacturing, the substrate 11 and the curved prism units 12 are preferably combined by means of adhesion or other suitable means. The curved prism units 12 are formed on the substrate 11 by die assemblies, press rolling machines, mold pressing or other equivalent apparatuses. The flexible, transparent material of the substrate 11 is preferably selected from the group consisting of polyethylene-terephthalate (PET), polyethylene (PE), polyethylene napthalate (PEN), polycarbonate (PC), polyvinyl alcohol (PVA), polyvinyl chloride (PVC), macromolecule and mixtures thereof. In a preferred embodiment, the transparent material of the curved prism units 12 are made from UV adhesive, such as UV curable adhesive.

Referring again to FIGS. 3, 4 and 12, the curved prism units 12 contain a predetermined amount of the light scattering particles 13 whose weight percent is in the range of 1 wt % to 35 wt %, more preferably in the range of 1 wt % to 25 wt %. The light scattering particles 13 are preferably made from a material different from that of the curved prism units 12, selecting from plastic or glass for example. Preferably, the material of the light scattering particles 13 is selected from the group consisting of SiO₂, Al₂O₃, B₂O₃, CaO, MgO, silicon resin, polyester resin, styrene resin and mixtures thereof. In a preferred embodiment, the curved prism units 12 contain a predetermined amount of the light scattering particles 13 which occupies in the range of weight percentage from 1 to 35. In another preferred embodiment, the light scattering particles 13 are in the range of sizes from 0.5 μm to 30 μm, more preferably in a range of sizes from 0.5 μm to 10 μm. In another preferred embodiment, the light scattering particles 13 can be in the form of sphere, roughly shaped sphere, olive, ovum and irregular faceted particle.

With continued reference to FIGS. 3 through 5, the first meandering surface 12a of the curved prism unit 12 provides variations in curvature similar or dissimilar to those of the second meandering surface 12b. In a preferred embodiment, the light scattering particles 13 embedded in the curved prism units 12 can be in the form of regular shapes or regular-free shapes. In another preferred embodiment, the material of the light scattering particles 13 has a refractive index different from that of the curved prism units 12. Advantageously, the curved prism units 12 and the light scattering particles 13 can provide various angles of emitting light on the first surface 11a of the substrate 11. For example, the curved prism units 12 and the light scattering particles 13 disperse light into two light beams 14, 15, as indicated by the direction arrows in FIG. 5.

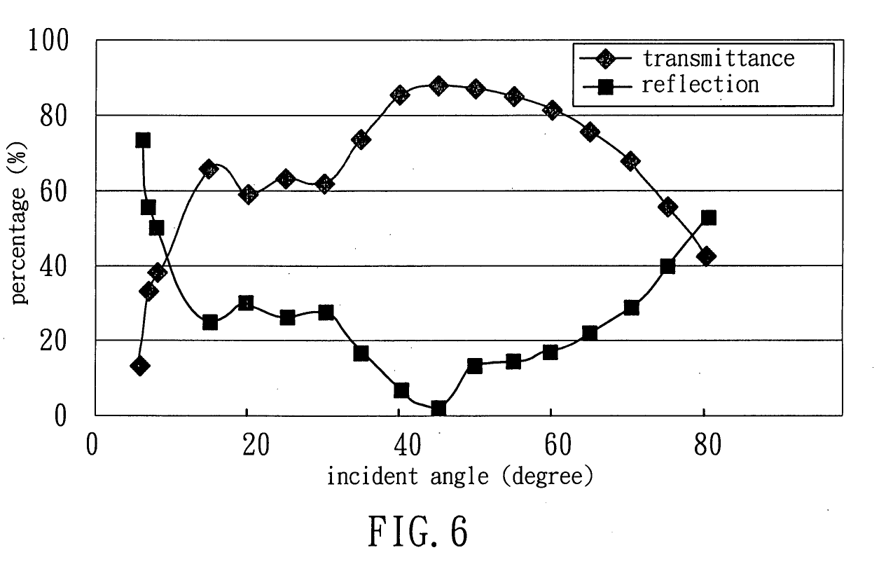

Still referring to FIG. 6, the light beam 14 passes through some of the light scattering particles 13 of one curved prism unit 12 with a greater angle of incidence with respect to a vertical direction of the first surface 11a of the substrate 11 while the light beam 15 passes through some of the light scattering particles 13 of another curved prism unit 12 with a smaller angle of incidence, such as an angle of 6 degrees to 9 degrees. Both of the two light beams 14 and 15 are scattered by the light scattering particle 13, regardless of the greater or smaller angle of incidence. Thus the incident light beams 14 and 15 are scattered before exiting the first meandering surface 12a and the second meandering surface 12b of the curved prism unit 12. Consequently, the light scattering particles 13 can provide a perfect degree of haze of the brightness enhancement film 1, and can reduce structural defects of the brightness enhancement film 1.

Moreover, the light scattering particles 13 of the brightness enhancement film 1 can eliminate the total internal reflection of emitting light on the first meandering surface 12a and the second meandering surface 12b of the curved prism unit 12. Accordingly, the light scattering particles 13 of the brightness enhancement film 1 accomplishes a perfect degree of brightness emitted on the curved prism unit 12.

Turning now to FIG. 6, a chart of two curves illustrating transmission and reflection efficiency in relation to incident angles with respect to the brightness enhancement film in accordance with the preferred embodiment of the present invention is shown. Referring back to FIG. 5, the light scattering particles 13 disperses the light beams 14 and 15 to provide preferred transmission and reflection efficiency of light on the first surface 11a of the substrate 11.

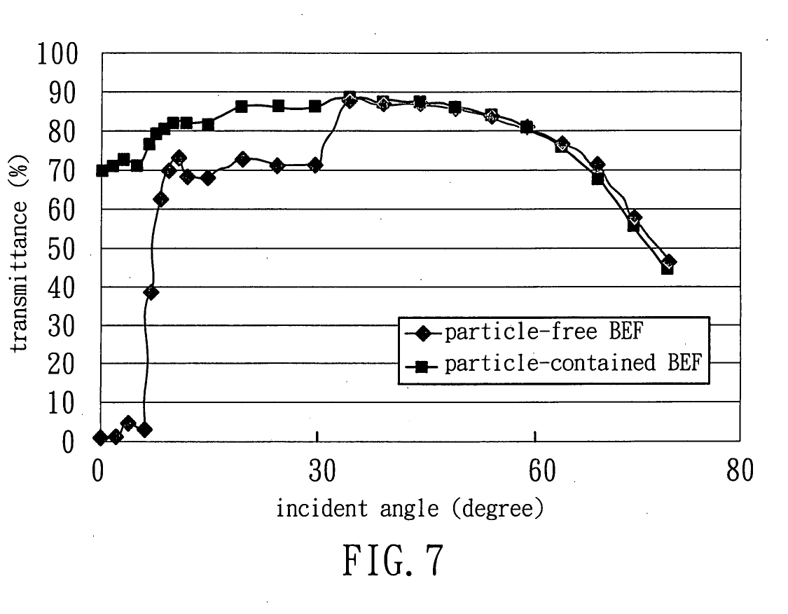

Turning now to FIG. 7, a chart of two curves illustrating transmittance of light in relation to incident angles of light of a particle-contained brightness enhancement film and a particle-free brightness enhancement film is shown. It is apparent from FIG. 7 that comparing the particle-contained brightness enhancement film (identified as particle-contained BEF) with the particle-free brightness enhancement film (identified as particle-free BEF), the particle-contained curved prism units 12 can provide a preferred degree of light transmission efficiency within a range of incident angles from about 0 degrees to about 35 degrees. Particularly, the brightness enhancement film 1 of the present invention can provide a significantly greater degree of light transmittance within a range of incident angles from about 0 degrees to about 10 degrees. Advantageously, the brightness enhancement film 1 of the present invention can provide a degree of transmittance of incident light greater 10% to 90% than that of the particle-free brightness enhancement film. Furthermore, the light scattering particles 13 of the brightness enhancement film 1 of the present invention can increase a degree of brightness within a relatively wider visual angle. Particularly, the light scattering particles 13 carry out a perfect degree of light diffusion such that a light diffusing film or the like will be omitted in a backlight module. Advantageously, the brightness enhancement film 1 of the present invention can reduce a total number of members using in the backlight module.

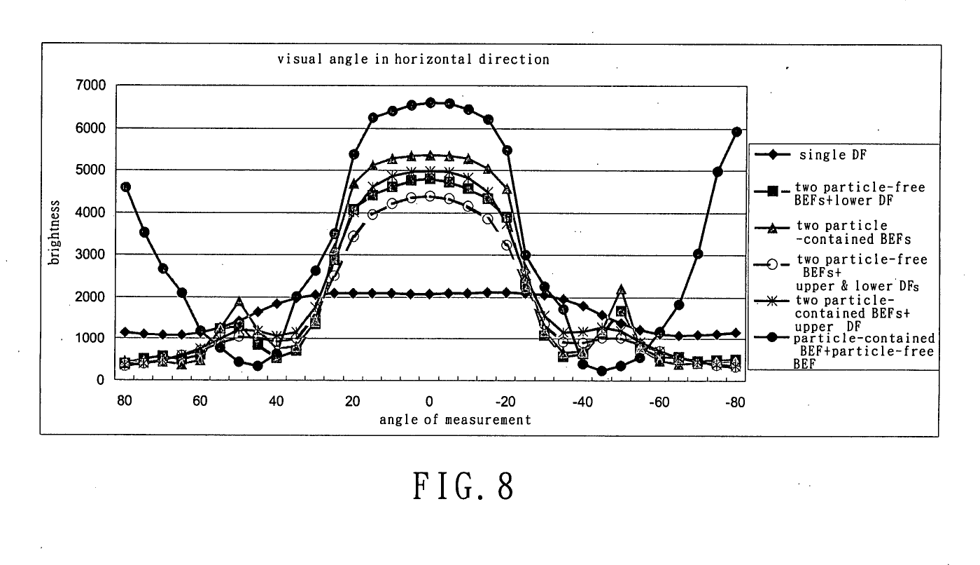

Turning now to FIG. 8, a chart illustrating brightness of various types of brightness enhancement films in relation to visual angles along a horizontal direction of viewing is shown. The types of the brightness enhancement films include a single diffusing film (identified as DF); two particle-free brightness enhancement films and a lower diffusing film; two particle-contained brightness enhancement films (i.e. two sheets of the preferred embodiment); two particle-free brightness enhancement films and upper and lower diffusing films (DFs); two particle-contained brightness enhancement films (i.e. two sheets of the preferred embodiment) and an upper diffusing film (DFs); and a particle-contained brightness enhancement film and a particle-free brightness enhancement films. It is apparent from FIG. 8 that the combination of a single sheet of the particle-contained BEF with a single sheet of the particle-free BEF provides a wider degree of visual angle along a horizontal direction.

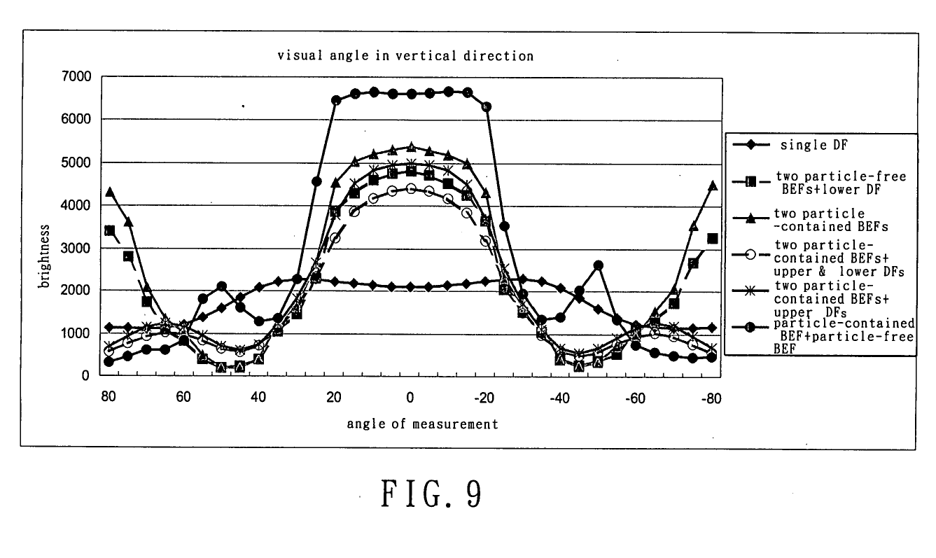

Turning now to FIG. 9, a chart illustrating brightness of various types of brightness enhancement films in relation to visual angles along a vertical direction of viewing is shown. It is apparent from FIG. 9 that the combination of a single sheet of the particle-contained BEF with a single sheet of the particle-free BEF provides a wider degree of visual angle along a vertical direction.

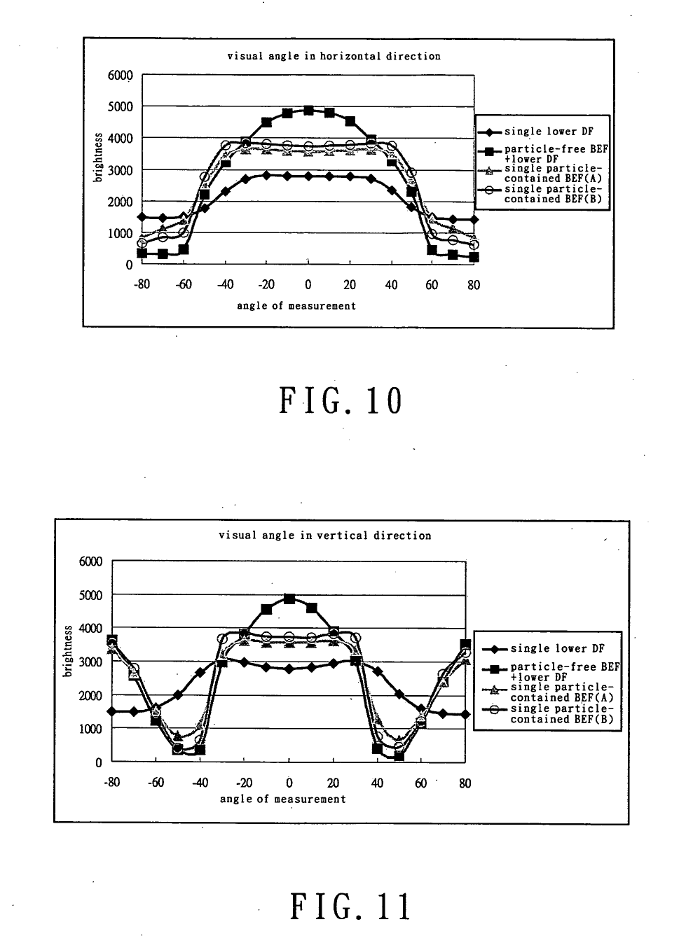

Turning now to FIGS. 10 and 11, two charts illustrating brightness of various types of the brightness enhancement films in relation to visual angles along horizontal and vertical direction of viewing are shown. The types of the brightness enhancement films include a single lower diffusing film (identified as DF); a particle-free brightness enhancement film and a lower diffusing film; a single particle-contained brightness enhancement films “A” (i.e. a sheet of the preferred embodiment); and a single particle-contained brightness enhancement films “B”. The particle-contained brightness enhancement film “A” contains a predetermined amount of the light scattering particles 13 greater than that of the particle-contained brightness enhancement films “B”. It is apparent from FIGS. 10 and 11 that a single sheet of the particle-contained BEF of the present invention provides a wider degree of visual angle along horizontal and vertical directions than that of a single sheet of the lower DF or a combination of the particle-free BEF with a lower DF. Particularly, a single sheet of the particle-contained BEF of the present invention provides a uniform brightness within a half-luminance angle from about 40 degrees to about −40 degrees along horizontal and vertical directions comparing with the combination of the particle-free BEF with the lower DF. In FIG. 10, a single sheet of the particle-contained BEF of the present invention provides a degree of maximum visual angle of about 53 degrees along a horizontal direction comparing with 42 degrees of a conventional BEF. In FIG. 11, a single sheet of the particle-contained BEF of the present invention provides a half-luminance angle of about 35 degrees along a vertical direction comparing with 32 degrees of a conventional BEF.

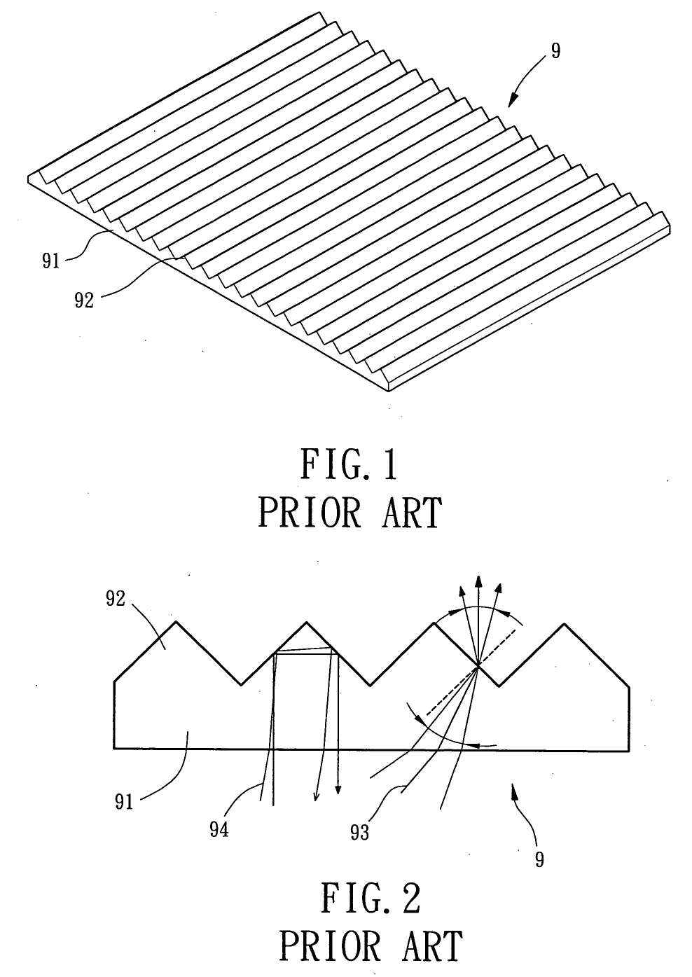

Referring back to FIGS. 1 and 2, the conventional brightness enhancement film 9 is absent the prisms 92 that include light scattering particles such that the conventional brightness enhancement film 9 cannot provide a preferred degree of light transmittance. In comparison with the conventional brightness enhancement film 9 as shown in FIG. 2, the light scattering particles 13 of the brightness enhancement film 1 of the present invention, as best shown in FIG. 5, can enhance light transmittance and reduce total internal reflection of light on the first meandering surface 12a and the second meandering surface 12b of the curved prism unit 12.

Turning now to FIG. 4A, reference numerals of the second embodiment of the present invention have applied the identical numerals of the first embodiment. The construction of the brightness enhancement film in accordance with the second embodiment of the present invention has similar configuration and same function as that of the first embodiment and detailed descriptions may be omitted.

In comparison with the first embodiment, the first meandering surface 12a and the second meandering surface 12b of the curved prism unit 12 of the second embodiment include a plurality of lateral ridges 121 arranged in staggered manner in a longitudinal direction. Each of the lateral ridges 121 connects between the common ridge and the common trough line so that the curved prism units 12 are longitudinally extended in a meandering line to provide with great changes in curvature on the lateral ridges 121. Furthermore, each of the lateral ridges 121 can be selectively has the same uniform curvature or various curvatures.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A brightness enhancement film, said brightness enhancement film being arranged to be used in a liquid crystal display, comprising:
a substrate including a first surface and a second surface substantially parallel to said first surface, and vertically transmitting light between the first surface and the second surface;
a plurality of curved prism units juxtaposed on the first surface of the substrate, each of the curved prism units having a longitudinal direction and including a ridge, a trough line, and at least one meandering surface located between said ridge and trough line, said ridge and said meandering surface extending and meandering with respect to the longitudinal direction to provide changes in curvature that are able to refract light in two dimensions, wherein directions of said ridge and said meandering surface relative to said longitudinal direction vary along a length of each of the prism units; and
a plurality of light scattering particles disposed in the curved prism units, said light scattering particles being capable of diffusing light in the curved prism units.

2. The brightness enhancement film as defined in claim 1, wherein a predetermined amount of the light scattering particles occupy in the range of weight percentage from 1 to 35 within a total material of 100 weight percentage of the curved prism units.

3. The brightness enhancement film as defined in claim 1, wherein the light scattering particles are made from plastic or glass.

4. The brightness enhancement film as defined in claim 1, wherein the light scattering particles are made from a material selected from the group consisting of SiO₂, Al₂O₃, B₂O₃, CaO, MgO, silicon resin, polyester resin, styrene resin and mixtures thereof.

5. The brightness enhancement film as defined in claim 1, wherein the light scattering particles are in a range of sizes from 0.5 μm to 30 μm.

6. The brightness enhancement film as defined in claim 1, wherein the light scattering particle is in the form of sphere, roughly shaped sphere, olive, ovum and irregular faceted particle.

7. The brightness enhancement film as defined in claim 1, wherein the curved prism unit includes a plurality of lateral ridges arranged on the meandering surface.

8. The brightness enhancement film as defined in claim 1, wherein the curved prism unit includes a first meandering surface and a second meandering surface.

9. The brightness enhancement film as defined in claim 8, wherein each of the first meandering surface and the second meandering surface includes a plurality of lateral ridges; and wherein the lateral ridges of the first meandering surface and the lateral ridges of the second meandering surface are arranged in staggered manner in a longitudinal direction to provide changes in curvature.

10. The brightness enhancement film as defined in claim 8, wherein an included angle formed between the first meandering surface and the second meandering surface located at the ridge of the curved prism unit is in the range of 70 degrees to 160 degrees.

11. The brightness enhancement film as defined in claim 1, wherein each meandering surface of the curved prism units provides regular changes in curvature.

12. The brightness enhancement film as defined in claim 1, wherein each meandering surface of the curved prism units provides free of regular changes in curvature.

13. The brightness enhancement film as defined in claim 1, wherein each of the curved prism units has a vertical height with respect to the first surface of the substrate; and wherein the vertical height of the curved prism unit is in the range of 10 μm to 100 μm.

14. The brightness enhancement film as defined in claim 1, wherein each of the curved prism units has a horizontal width with respect to the first surface of the substrate; and wherein the horizontal width of the curved prism unit is in the range of 10 μm to 250 μm.

15. The brightness enhancement film as defined in claim 1, wherein the substrate is made from a flexible, transparent material.

16. The brightness enhancement film as defined in claim 15, wherein the flexible, transparent material of the substrate is selected from the group consisting of polyethylene-terephthalate (PET), polyethylene (PE), polyethylene napthalate (PEN), polycarbonate (PC), polyvinyl alcohol (PVA), polyvinyl chloride (PVC), macromolecule and mixtures thereof.

17. The brightness enhancement film as defined in claim 1, wherein the light scattering particles enhance a degree of transmittance of incident light greater 10% to 90% than that of a particle-free brightness enhancement film within an incident angle of 10 degrees.
